(19) United States
(12) Patent Application Publication
(10) Pub. No.: US 2025/0316091 A1
(43) Pub. Date: Oct. 9, 2025

(54) DYNAMIC PRESENTATION OF VEHICLE ACTION SUGGESTIONS USING MACHINE LEARNING-BASED IMAGE SEGMENTATION

(71) Applicant: Rivian IP Holdings, LLC, Irvine, CA (US)

(72) Inventors: Rutu Rahul GANDHI, Sunnyvale, CA (US); Sreenivasulu GOSANGI, San Ramon, CA (US); Geoffrey Francis BURNS, Palo Alto, CA (US)

(21) Appl. No.: 18/628,574

(22) Filed: Apr. 5, 2024

(51) Int. Cl. G06V 20/58; B60W 50/14; G06T 7/11; G06V 10/44; G06V 10/764; G06V 20/70

(52) U.S. Cl. CPC G06V 20/58; B60W 50/14; G06T 7/11; G06V 10/44; G06V 10/764; G06V 20/70; G06T 2207/20084

(57) ABSTRACT

Aspects of the subject disclosure relate to dynamic presentation of vehicle action suggestions using machine learning-based image segmentation on a vehicle. A device implementing the subject technology may include a processor configured to obtain an image from a camera of the vehicle. The processor is also configured to determine one or more semantic features in the image by performing image segmentation on the image using a trained machine learning model. The processor is also configured to detect, based on the one or more semantic features, a vehicle path condition in the image. The processor is also configured to display, on a user interface, a notification indicating a plurality of suggestions that can be a respective action to be executed by the vehicle based on the detected vehicle path condition.

### INTRODUCTION

Vehicles, including electric vehicles, can include camera systems and machine learning systems. For example, a vehicle camera system can include dynamic presentation of vehicle action suggestions using machine learning-based image segmentation on a vehicle.

### SUMMARY

In the realm of off-road and adventurous driving, individuals lacking experience often encounter challenges in decision-making when confronted with specific conditions or terrains. The subject technology addresses this through the introduction of dynamic presentation of vehicle action suggestions using machine learning-based image segmentation, terrain detection and alert system specifically configured for off-road and adventurous conditions. The subject technology implements a deep learning model for the image segmentation that is deployed on an electronic control unit (ECU) of the vehicle.

The terrain detection and alert system encompasses a suggestion mechanism for throttle, steering, speed adjustments, ground clearance, tire pressure, among others. For example, the system obtains semantic features from an image by way of image segmentation for hindrance detection and/or terrain detection to inform a driver of possible challenges along a path of the vehicle and/or feed into the suggestion mechanism for recommending an action to be executed by the vehicle to handle such challenges. The suggestions may be provided to an infotainment system and may include the option to the driver to select one of the suggestions for enabling the driver to take the recommended vehicle action.

In accordance with one or more aspects of the disclosure, a method includes obtaining, by one or more processors, an image from a camera of a vehicle. The method also includes determining, by the one or more processors, one or more semantic features in the image by performing image segmentation on the image using a trained machine learning model. The method also includes detecting, by the one or more processors, based on the one or more semantic features, a vehicle path condition in the image. The method also includes displaying, on a user interface, a notification indicating a plurality of suggestions that can be a respective action to be executed by the vehicle based on the detected vehicle path condition.

In accordance with one or more aspects of the disclosure, a system is provided that includes memory; and at least one processor coupled to the memory and configured to generate a segmentation mask that includes a plurality of semantic features that correspond to respective pixels of an image from a camera of a vehicle, wherein the segmentation mask is generated by performing image segmentation on the image using a trained machine learning model. The at least one processor is also configured to detect one or more vehicle path conditions in the image by classifying each of the plurality of semantic features in the segmentation mask. The at least one processor is also configured to provide for display one or more suggestions that can be a respective action to be executed by the vehicle based on the detected one or more vehicle path conditions.

In accordance with one or more aspects of the disclosure, a vehicle including a camera; and a processor configured to provide an image from the camera to a trained machine learning model configured to generate a segmentation mask that includes a plurality of semantic features that correspond to respective pixels of the image and detect one or more vehicle path conditions in the image by classifying each of the plurality of semantic features in the segmentation mask. The processor is also configured to provide for display one or more suggestions that can be a respective action to be executed by the vehicle based on the detected one or more vehicle path conditions. The processor is also configured to cause the respective action to be executed by the vehicle based at least in part on a received input indicating selection of at least one of the one or more suggestions.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic perspective side view of an example implementation of a vehicle in accordance with one or more implementations of the subject technology.

FIG. 2 illustrates an example electronic device that may implement machine learning-based image segmentation for dynamic presentation of vehicle action suggestions in accordance with one or more implementations.

FIG. 3 illustrates a flow diagram of an example process for dynamic presentation of vehicle action suggestions using machine learning-based image segmentation in accordance with one or more implementations of the subject technology.

FIG. 4 illustrates a system flow diagram for dynamic presentation of vehicle action suggestions using machine learning-based image segmentation in accordance with one or more implementations of the subject technology.

FIG. 5 illustrates a system flow diagram for dynamic presentation of adventurous vehicle maneuver suggestions in accordance with one or more implementations of the subject technology.

FIG. 6 illustrates a flow diagram of an example process for dynamic presentation of vehicle accessory and action predictions in accordance with one or more implementations of the subject technology.

FIG. 7 illustrates a system flow diagram for dynamic presentation of vehicle accessory and action predictions in accordance with one or more implementations of the subject technology.

FIG. 8 illustrates a flow diagram of an example process for dynamic presentation of vehicle action suggestions based on speech input in accordance with one or more implementations of the subject technology.

FIG. 9 illustrates a system flow diagram for dynamic presentation of vehicle action suggestions based on speech input in accordance with one or more implementations of the subject technology.

FIG. 10 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

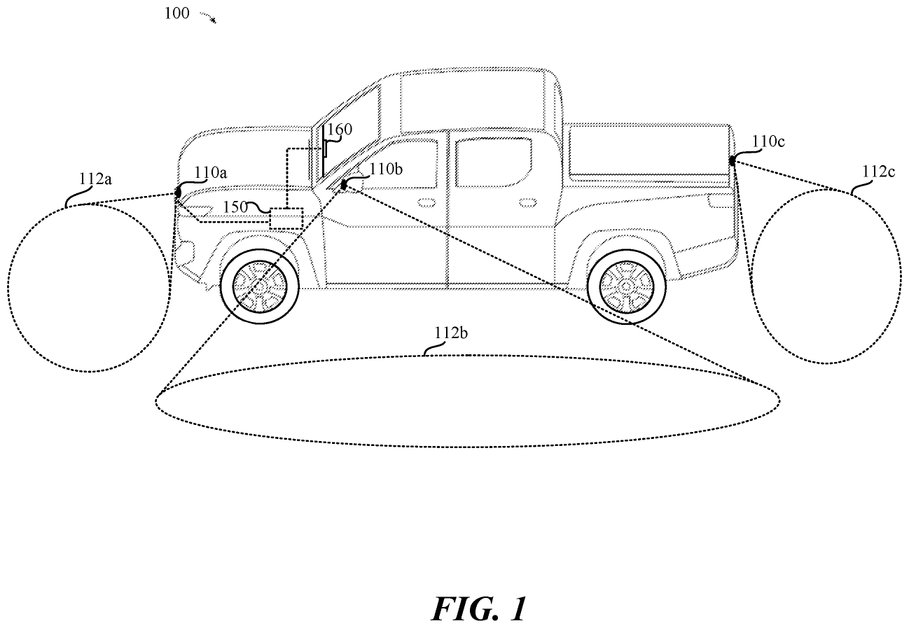

FIG. 1 illustrates a schematic perspective side view of an example implementation of a vehicle 100 in accordance with one or more implementations of the subject technology. For explanatory purposes, the vehicle 100 is illustrated in FIG. 1 as a truck. However, the vehicle 100 is not limited to a truck and may also be, for example, a sport utility vehicle, a van, a delivery van, a semi-truck, an aircraft, a watercraft, a car, a motorcycle, or generally any type of vehicle or other moveable apparatus having a camera system for dynamic presentation of vehicle action suggestions using machine learning-based image segmentation on the vehicle 100.

The vehicle 100 includes cameras 110a, 110b, 110c, which may be positioned at fixed and predefined locations on the vehicle 100 to capture images of different areas surrounding the vehicle 100 from multiple angles, different fields of view, and the like. By using multiple cameras on the vehicle 100, the system can capture a wider field of view, allowing the driver of the vehicle 100 to see more of the surroundings and make safer maneuvers. For example, the cameras 110a, 110b, 110c on the vehicle 100 can be positioned on the front, back, and sides, such as the camera 110a located at the front of the vehicle 100 to capture an image of area 112a, the camera 110b located at the left side of the vehicle 100 to capture an image of area 112b, and the camera 110c located at the rear of the vehicle 100 to capture an image of area 112c. Although FIG. 1 illustrates cameras 110a, 110b, 110c, it should be appreciated that the vehicle 100 may include an arbitrary number of cameras on the vehicle 100. The number of cameras used in this configuration may depend on the size of the vehicle 100.

In one or more implementations, one or more of the cameras 110a, 110b, 110c includes a fisheye lens such that fisheye image data can be captured from the respective camera. The images captured by the cameras 110a, 110b, 110c can be stitched together to produce a contiguous field of view surrounding the vehicle 100.

To provide the most comprehensive and accurate visualization surrounding the vehicle 100, the vehicle 100 may potentially incorporate data from multiple types of sensors in addition to the cameras 110a, 110b, 110c. This can include sensors such as lidar or radar to provide additional depth and distance information, as well as sensors to detect the orientation and movement of the vehicle 100.

The vehicle 100 also includes an electronic control unit (ECU) 150. Since image segmentation can be computationally intensive, the ECU 150 may include a powerful processing unit such as a dedicated graphics processing unit (GPU) or field-programmable gate array (FPGA) to perform the necessary image processing in real-time.

In one or more implementations, the ECU 150 includes, or is electrically coupled to one or more geo-location sensors located on the vehicle 100. In one or more other implementations, one or more of the cameras 110a, 110b, 110c, one or more of the geo-location sensors 330, and/or other sensors of the vehicle 100 may periodically capture location data to determine a surround view of the vehicle 100. In one or more implementations, one or more of the cameras 110a, 110b, 110c of the vehicle 100 may periodically capture one or more images, and the vehicle 100 may analyze the images (e.g., via semantic image segmentation and/or object recognition) to determine whether any obstructions and/or certain types of terrain are detected as approaching the vehicle 100 along a path trajectory. Where the location data is captured as one or more images (e.g., by the cameras 110a, 110b, 110c), the vehicle 100 may analyze the images to determine whether such obstructions around a vicinity of the vehicle 100 are visible in the images. Where the location data is captured as global positioning system (GPS) data (e.g., by the geo-location sensors), the vehicle 100 may analyze the location data with respect to a known route trajectory of the vehicle 100 to determine whether any detected objects are located along the route trajectory of the vehicle 100.

The vehicle 100 includes an infotainment system 160. In one or more implementations, the infotainment system 160 is communicatively coupled to the ECU 150. The infotainment system 160 enables a user to communicate information and select commands to the ECU 150. The infotainment system 160 may enable the ECU 150 to communicate information to users. The infotainment system 160 may potentially include additional features such as object detection or alert notifications to further enhance driver awareness and safety.

In some aspects, the cameras 110a, 110b, 110c can be used for other applications such as off-road under-body camera feed for rock crawling or other adventurous maneuvers. The cameras intended for use on the vehicle 100 can potentially be designed to withstand harsh environments and extreme conditions, such as dust, dirt, water, and impact resistance.

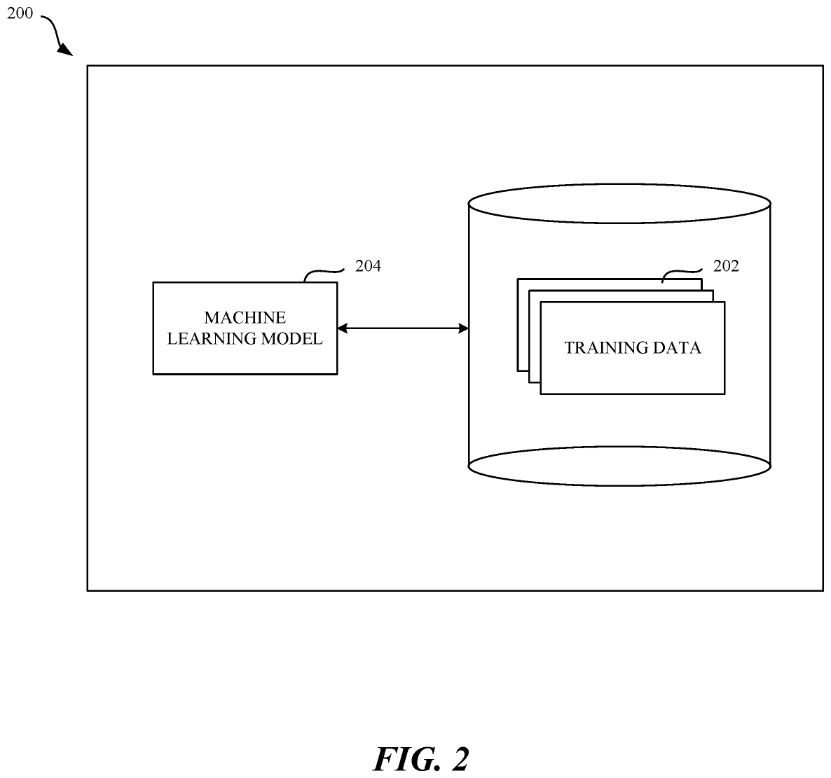

In the realm of off-road and adventurous driving, individuals lacking experience often encounter challenges in decision-making when confronted with specific conditions or terrains. The ECU 150 may provide dynamic presentation of vehicle action suggestions using machine learning-based image segmentation, terrain detection and alert system specifically designed for off-road and adventurous conditions. The ECU 150 can deploy a deep learning model for the image segmentation, which will be discussed in more detail with reference to FIG. 2.

The terrain detection and alert system encompasses a suggestion mechanism for throttle, steering, speed adjustments, ground clearance, tire pressure, among others. For example, the ECU 150 obtains semantic features from an image (e.g., captured by at least one of cameras 110a, 110b, 110c) by way of image segmentation for hindrance detection and/or terrain detection to inform a driver of possible challenges along a path of the vehicle 100 and/or feed into the suggestion mechanism for recommending an action to be executed by the vehicle 100 to handle such challenges.

In image segmentation, semantic features refer to the visual characteristics or elements within an image that carry meaningful information related to the content or semantics of the objects present. These features are derived from the content of the image itself and help in understanding the context or meaning of different parts of the image. These semantic features can be used to distinguish and classify different parts of the image based on their semantic significance, aiding in the accurate identification of objects or regions within the image. Semantic features can include various visual cues such as colors, textures, shapes, edges, patterns, or object arrangements that represent meaningful information about the objects or regions in the image.

To be usable by drivers, the subject system would need to provide a clear and intuitive user interface for displaying content relating to the vehicle 100. This could involve integrating the adventure assist features with existing dashboard displays or providing a separate display dedicated to the adventure assist features. For example, the suggestions may be provided to the infotainment system 160 and may include the option to the driver to select one of the suggestions for enabling the driver to take the recommended vehicle action.

During driving, specific areas under the vehicle 100 may be obstructed from view due to physical hindrances. Utilizing a fisheye camera (e.g., 100a-c) with a wider field of view enables enhanced data capture. Through the infotainment system 160, it becomes feasible to simulate an augmented view, creating the impression of additional information by displaying obscured areas as if the obstruction were absent or partially removed. This approach enhances the visual information presented to the user of the vehicle 100.

FIG. 2 illustrates an example electronic device 200 that may implement machine learning-based image segmentation for dynamic presentation of vehicle action suggestions in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 202 for training a machine learning model 204. The electronic device 200 can perform data pre-processing by pre-processing the collected data to make it suitable for training the machine learning model 204. In one or more implementations, the ECU 150 is, or includes at least a portion of, the electronic system 200.

The electronic device 200 can perform model selection by selecting a suitable machine learning algorithm, such as decision trees, neural networks, or support vector machines, that can learn from the pre-processed data and perform the desired actions. This involves splitting the data into training, validation, and test sets, setting hyperparameters, and using an optimization algorithm to minimize the model's loss or error on the training data 202.

The electronic device 200 can perform training of the machine learning model 204 by training the selected model on the pre-processed data. In an example, the ECU 150 may utilize one or more machine learning algorithms that uses the training data 202 for training the machine learning model 204. In one or more implementations, the electronic system 200 may adapt the model architecture to account for specific characteristics of certain images (e.g., fisheye) by modifying convolutional neural network (CNN) architectures or incorporate specific layers that can better handle distorted inputs.

In one or more implementations, the training data 202 may include training data obtained by a device on which a trained machine learning model is deployed and/or training data obtained by other devices. The training data 202 may include labeled image data, including labels for fisheye images. The training data 202 may include a large amount of training data that may be required as part of the model training. The training data 202 may consist of pairs of images that have some degree of overlap, which is used to perform the stitching operation. The pairs of images used for training are often obtained by taking multiple photos of the same scene from different viewpoints or by using a panoramic camera that captures a series of overlapping images as it rotates. The images in each pair are then transformed so that they overlap, and the transformation parameters are recorded. In addition to the input image pairs and their corresponding transformation parameters, the training data 202 may also include information about the image content, such as edge maps or feature descriptors, which can be used to guide the image segmentation process. During training, the machine learning model 204 can learn to predict the transformation parameters that align the input images and produce a seamless output image. The algorithm can be trained using a large number of image pairs, with the aim of minimizing a loss function that measures the difference between the predicted and ground truth transformation parameters. In some aspects, the training process may involve data augmentation techniques, such as cropping, rotation, and scaling, to increase the diversity of the training data and improve the generalization performance of the algorithm.

Training the machine learning model 204 with fisheye image data included in the training data 202 can present some unique challenges and considerations compared to using standard images. Fisheye lenses can introduce significant distortion, which can affect object proportions and spatial relationships. In this regard, correcting this distortion before training can help the machine learning model 204 better understand the true shapes and sizes of objects. In one or more implementations, the electronic system 200 can prioritize preprocessing steps that rectify the distortion and reproject fisheye images into a rectilinear format. The electronic system 200 can apply projection techniques such as equidistant, equisolid, or stereographic projection to transform fisheye images into a more standard perspective. In one or more other implementations, the training process may involve data augmentation techniques tailored to fisheye images, such as random distortion or warping, to generate synthetic fisheye data by simulating distortions or applying transformations that mimic fisheye effects and help the machine learning model 204 generalize better to unseen fisheye data. In one or more implementations, the training data 202 can include annotations or ground truth segmentations that align with the fisheye-distorted perspective.

The system can perform model evaluation by evaluating the trained model on the validation and test sets to ensure that it performs well and generalizes to new data. This includes calculating metrics such as mean intersection-over-union (IOU) and pixel accuracy. The mean IOU metric is an evaluation metric for semantic image segmentation. In one or more implementations, the IOU value can be calculated by dividing the intersection of predicted and ground truth pixels by the union of these pixels for each class in the segmentation task and the mean IOU metric can be calculated from it by summing up the IOU values for all individual classes in the segmentation task and dividing by the total number of classes. A higher mean IOU metric in a range of 0 to 1 can indicate a better overall segmentation performance. The pixel accuracy metric may represent a percent of pixels in the image that are classified correctly. The system can perform model deployment once the trained model has been evaluated and validated. Overall, training and implementing the machine learning model 204 to perform actions may include a combination of data collection, pre-processing, model selection, training, evaluation, and deployment.

In some implementations, the machine learning model 204 may be used as a computer vision technique that uses artificial neural networks to automatically perform semantic image segmentation. Semantic image segmentation is a computer vision task that involves partitioning an image into multiple segments, each representing a particular class or category. The machine learning model 204 can assign a label to each pixel in the image, effectively creating a pixel-level understanding of the scene. Neural networks, especially convolutional neural networks (CNNs), may be selected for this task due to their ability to learn hierarchical representations.

In one or more implementations, the process of semantic image segmentation using neural networks may begin with an input image (e.g., fisheye image) that needs to be segmented. This image can be of any size, and each pixel in the image can be assigned a class label. The electronic system 200 can employ a neural network architecture designed for semantic segmentation. In one or more implementations, these architectures may be variations of CNNs, such as fully convolutional networks (FCNs), U-Net, SegNet, or DecpLab, Mask R-CNN, Proportional-Integral-Derivative networks, among others, which are specifically tailored to capture spatial information while maintaining resolution. The architecture can include an encoder-decoder structure. The encoder may extract high-level features from the input image through convolutional and pooling layers, gradually reducing spatial dimensions while increasing the number of feature maps. The decoder may then reconstruct the segmented image from these learned features by upsampling and combining information from different layers. In one or more other implementations, these architectures can use skip connections that link encoder and decoder layers at multiple resolutions. These connections facilitate preservation of finer details during upsampling and can improve segmentation accuracy.

In one or more implementations, the machine learning model 204 can be trained using a labeled dataset where each pixel in the input image has an associated ground truth label. During training, the machine learning model 204 may learn to predict the class of each pixel by minimizing a loss function that quantifies the difference between predicted and ground truth segmentations. In one or more implementations, the machine learning model 204 may be trained using loss functions that account for distortions as may be found in fisheye images. Weighted losses or custom loss functions that penalize errors in distorted regions can be beneficial. In one or more other implementations, the machine learning model 204 may be trained with pre-trained models and fine-tune them with fisheye-specific data to leverage features learned from standard images. Once trained, the machine learning model 204 can be used to predict semantic information and boundary region information for one or more pixels of new images. The output is a segmented image where each pixel is assigned a label corresponding to the class it belongs to (e.g., sand, snow, water, large rock, crevice, large obstruction, vegetation, etc.).

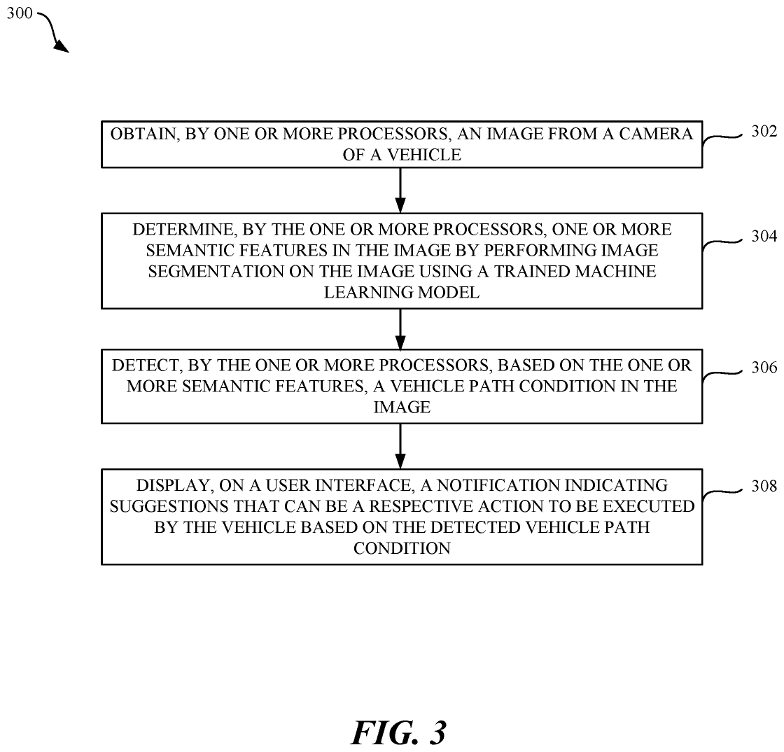

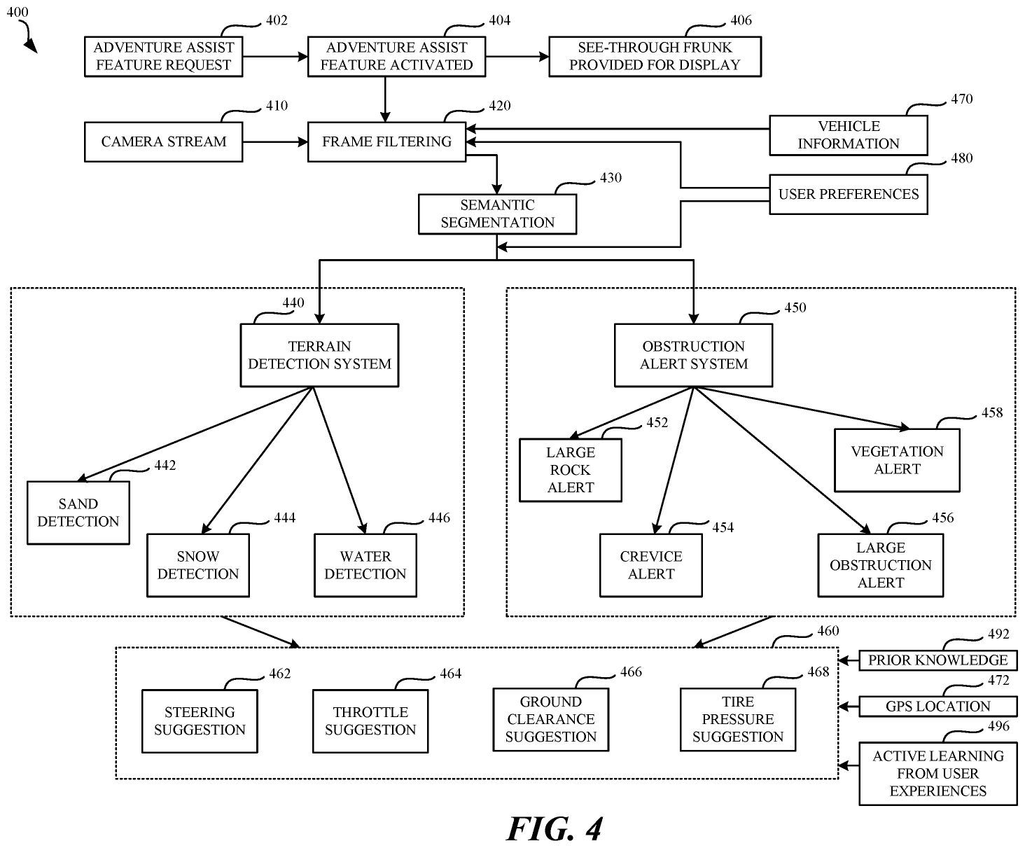

FIG. 3 illustrates a flow diagram of an example process 300 for dynamic presentation of vehicle action suggestions using machine learning-based image segmentation in accordance with one or more implementations of the subject technology. For explanatory purposes, the process 300 is primarily described herein with reference to the vehicle 100 of FIG. 1 and/or various components thereof. However, the process 300 is not limited to the vehicle 100 of FIG. 1, and one or more steps (or operations) of the process 300 may be performed by one or more other structural components of the vehicle 100 and/or of other suitable moveable apparatuses, devices, or systems. Further, for explanatory purposes, some of the steps of the process 300 are described herein as occurring in serial, or linearly. However, multiple steps of the process 300 may occur in parallel. In addition, the steps of the process 300 need not be performed in the order shown and/or one or more steps of the process 300 need not be performed and/or can be replaced by other operations. Moreover, for explanatory purposes and for brevity of disclosure, some of the steps of the process 300 are described herein with reference to FIG. 4. FIG. 4 illustrates a system flow diagram for dynamic presentation of vehicle action suggestions using machine learning-based image segmentation in accordance with one or more implementations of the subject technology.

Referring to FIG. 4, at 402, the vehicle 100 may receive an adventure assist feature request. For example, the driver (or passenger) of the vehicle 100 may provide selection of an option provided for display on the infotainment system 160 (FIG. 1) that causes a request for activating the adventure assist feature to be sent to the ECU 150 (FIG. 1). Presentation of the adventure assist feature for activation can be discretionary for the user, allowing the user to decide whether to engage it before driving, similar to a user-controlled autopilot feature. The objective is to avoid inundating the user with suggestions they may not desire during regular driving scenarios. Activation should primarily rely on user preference. For example, when driving in specific terrains such as sand dunes or near water bodies, the user of the vehicle 100 may opt to engage this adventure assist feature for suggestions.

The adventure assist feature as described herein with reference to FIG. 4 may refer to dynamic presentation of vehicle action suggestions using machine learning-based image segmentation, terrain detection and alert system specifically configured for off-road and adventurous conditions. The adventure assist feature can encompass a suggestion mechanism for throttle, steering, speed adjustments, ground clearance, tire pressure, among others. The suggestions may be provided to the infotainment system 160 (FIG. 1) and may include the option to the driver to select one of the suggestions for enabling the driver to take the recommended vehicle action.

Within the adventure assist feature, consideration may be given to the integration of two data sources: vehicle information and user information. The vehicle information block encompasses data collected from sensors and systems of the vehicle 100, providing comprehensive insights. Conversely, the user information block incorporates user preferences, allowing for customizable selections, such as preferences for specific terrain suggestions or comfort levels regarding certain directions. This inclusive approach enables information intake from both vehicle sensors and user preferences to enhance the functionality of the adventure assist feature.

At 404 in FIG. 4, the adventure assist feature is activated. For example, once the request is received by the ECU 150, the adventure assist feature is activated. The operation at 404 may serve as a notification indicating the activation status of the adventure assist feature rather than an initiating action. It can function as a response or confirmation of the active state when the user of the vehicle 100 engages the adventure assist feature.

In turn, at 406, an image representation of a see-through frunk is provided for display on the infotainment system 160. As used herein, the term “see-through frunk” can refer to a transparent or translucent front trunk compartment of the vehicle 100 in the context of electric vehicles, allowing an operator of the vehicle 100 to see the environment in front of and/or beneath the vehicle 100 without obstruction from the compartment. In some aspects, an image representation of the surrounding environment including the environment underneath the vehicle 100 can be provided for display on the infotainment system 160. The image representation of the see-through frunk may include an outline of the hood and/or front portion of the vehicle 100 that is overlaid on the image representation of the surrounding environment. The outline may be a predefined guideline of how the hood and/or front portion of the vehicle 100 is to be perceived by a user of the vehicle 100 and can be used to reference the vehicle 100 position relative to the surrounding environment.

Referring back to FIG. 3, at step 302, the vehicle 100 may obtain, using one or more processors (e.g., ECU 150, processing unit 1014), an image from a camera of the vehicle 100. Referring to FIG. 4, a camera stream 410 is provided, which can serve as the image data from the camera. Also referring to FIG. 4, the camera stream 410 is provided to a frame filtering module 420 that serves to filter the image data within the camera stream 410. For example, the frame filtering module 420 can receive image data (e.g., fisheye images) from at least one of the cameras 110a, 110b, 110c of FIG. 1 by way of the camera stream 410. In one or more other implementations, the frame filtering module 420 may receive one or more video frames included in the camera stream 410.

In one or more implementations, the current frame value constitutes the primary input to the machine learning model 204. The subject technology can involve an entire IQ pipeline, adopting a real-time approach where frames are filtered based on driving speed of the vehicle 100. Employing image similarity, identical frames are identified, and one or more representative frames can be passed to the machine learning model 204. This configuration can minimize processing redundancy and reduce the image segmentation workload, optimizing efficiency. For example, when operating a camera (e.g., either of cameras 110a-c) at 30 frames per second (FPS), not every frame necessitates semantic image segmentation; instead, the frame filtering module 420 can apply filtering criteria prior to input to a semantic segmentation module 430 so that the semantic segmentation module 430 can determine which frames require processing based on uniqueness and data content. In some implementations, the semantic segmentation module 430 is, or includes at least a portion of, the machine learning model 204. In one or more implementations, the frame filtering module 420 can receive vehicle information 470 and user preferences 480. The vehicle information 470 can include information such as GPS location of the vehicle 100, speed information of the vehicle 100, or other sensor information from sensors installed on the vehicle 100. In this regard, the frame filtering module 420 can filter the image data based at least in part on the vehicle information 470. The user preferences 480 can include a user preference for a terrain of interest and/or a user preference for a location of interest. In this regard, the frame filtering module 420 can filter the image data based at least in part on the user preferences 480.

In one or more other implementations, the frame filtering module 420 involves a time-based comparison of semantic features that may be fed back from the semantic segmentation module 430. For example, when the vehicle 100 is moving slowly, there's minimal distance displacement over time, resulting in similar surrounding features across consecutive frames. This similarity allows for the skipping of frames, such as every third frame or according to specific criteria. This approach can contribute to optimizing the semantic image segmentation by reducing processing demands, minimizing storage requirements, and streamlining processing time.

At step 304, the vehicle 100 may determine, using the one or more processors, one or more semantic features in the image by performing image segmentation on the image using a trained machine learning model (e.g., the machine learning model 204). Referring to FIG. 4, the semantic segmentation module 430 receives the frame filtering output and performs the image segmentation. For example, the semantic segmentation module 430 obtains semantic features from an image by way of image segmentation for hindrance detection and/or terrain detection to inform a driver of possible challenges along a path of the vehicle and/or feed into the suggestion mechanism for recommending an action to be executed by the vehicle to handle such challenges. In one or more implementations, the semantic segmentation module 430 includes at least a portion of the machine learning model 204 of the electronic system 200 to process the image and extract semantic features. In performing the image segmentation, the semantic segmentation module 430 may divide the image into a plurality of image segments and assign a semantic label to each of the plurality of image segments. In some aspects, each of the one or more semantic features includes the semantic label of a corresponding image segment of the plurality of image segments.

This portion of the machine learning model 204 as implemented in the semantic segmentation module 430 may represent an encoder that can extract high-level features from the input image through convolutional and pooling layers, gradually reducing spatial dimensions while increasing the number of feature maps. The image segmentation may identify various classes within an image or video frame (such as snow, water, vegetation). The image segmentation may be performed by the semantic segmentation module 430 prior to the bifurcation such that all classes within the image or video frame may be segmented accordingly at the output of the semantic segmentation module 430.

In one or more implementations, the semantic segmentation module 430 may output a segmentation mask that indicates the identified classes for respective pixels of the analyzed image. The image segmentation process assigns an identifier to each class within the segmentation mask, facilitating activation between the downstream systems (e.g., terrain detection system 440, obstruction alert system 450). In some implementations, the user preferences 480 is fed to the output of the semantic segmentation module 430 to facilitate the distribution of the semantic features to a downstream system of interest. As illustrated in FIG. 4, the segmentation mask is provided to each branch respectively including the terrain detection system 440 and the obstruction alert system 450. For example, each of the terrain detection system 440 and the obstruction alert system 450 may represent a separate neural network branch in the machine learning model 204 as implemented in the semantic segmentation module 430 that includes a decoder configured to reconstruct the segmented image from the corresponding learned semantic features by up-sampling and combining information from different layers within the machine learning model 204.

At step 306, the vehicle 100 may detect, using the one or more processors, based on the one or more semantic features, a vehicle path condition in the image. In detecting the vehicle path condition, the semantic segmentation module 430 may determine one or more boundary regions in the plurality of image segments. In some aspects, the vehicle path condition is detected based on the one or more semantic features and the one or more boundary regions.

The classification process facilitates the capability of each of the terrain detection system 440 and the obstruction alert system 450 to detect respective types of objects based on the segmentation output. Analysis can occur on a frame-by-frame basis, each image (or video frame) possessing an identifier for classification. Each of the terrain detection system 440 and the obstruction alert system 450 can analyze the same frame to ascertain its contents. In one or more implementations, segregating terrain and obstructions may necessitate distinct systems, albeit sharing the same segmentation mask between the systems for metadata acquisition. In one or more other implementations, the terrain and obstruction classification may be performed with the same model. For example, the terrain and obstruction classification may be performed via the same neural network branch in the machine learning model 204. In one or more other implementations, the machine learning model 204 may include a multi-task learning model such that each of the terrain detection system 440 and the obstruction alert system 450 corresponds to a separate task of the multi-task learning model.

In one or more implementations, the vehicle path condition can refer to a terrain detection. Referring to FIG. 4, the terrain detection system 440 receives the segmentation mask. At 442, the portion of the machine learning model 204 implemented as part of the terrain detection system 440 may perform sand detection. For example, the terrain detection system 440 may identify a sand type of terrain within one or more pixels in the segmentation mask, causing driving suggestions for sandy conditions to be provided. At 444, the portion of the machine learning model 204 implemented as part of the terrain detection system 440 may perform snow detection. For example, the terrain detection system 440 may identify a snow type of terrain within one or more pixels in the segmentation mask, causing driving suggestions for snowy conditions to be provided. At 446, the portion of the machine learning model 204 implemented as part of the terrain detection system 440 may perform water detection. For example, the terrain detection system 440 may identify a water type of terrain within one or more pixels in the segmentation mask, causing driving suggestions for wet conditions to be provided.

In one or more other implementations, the vehicle path condition can refer to an obstruction alert. Referring to FIG. 4, the obstruction alert system 450 receives the segmentation mask. At 452, the obstruction alert system 450 may detect a large rock and issue a large rock alert. For example, the portion of the machine learning model 204 implemented as part of the obstruction alert system 450 may identify a large rock within one or more pixels in the segmentation mask, causing driving suggestions for avoiding or maneuvering around the large rock to be provided. At 454, the obstruction alert system 450 may detect a crevice and issue a crevice alert. For example, the portion of the machine learning model 204 implemented as part of the obstruction alert system 450 may identify a crevice within one or more pixels in the segmentation mask, causing driving suggestions for avoiding or maneuvering around the crevice to be provided. At 456, the obstruction alert system 450 may detect a large obstruction and issue a large obstruction alert, activating prompt navigation guidance. For example, the portion of the machine learning model 204 implemented as part of the obstruction alert system 450 may identify a large obstruction within one or more pixels in the segmentation mask, causing driving suggestions for avoiding or maneuvering around the large obstruction to be provided. At 458, the obstruction alert system 450 may detect vegetation and issue a vegetation alert. For example, the portion of the machine learning model 204 implemented as part of the obstruction alert system 450 may identify vegetation within one or more pixels in the segmentation mask, causing driving suggestions for avoiding or maneuvering around the vegetation to be provided. These alerts can manifest on the infotainment system 160 by displaying the current camera view. Detected obstacles, such as a rock, may be visualized using symbols (e.g., an exclamation mark) or a highlighted indication (e.g., a noticeable red coloration), drawing attention to the specific obstruction for user acknowledgment.

In FIG. 4, the outputs of the terrain detection system 440 and the obstruction alert system 450 may be fed to a suggestion system 460 for alerting a user of the vehicle 100 with vehicle action suggestions based on the detected vehicle path conditions. In one or more implementations, the suggestion system 460 can issue a steering suggestion 462, a throttle suggestion 464, a ground clearance suggestion 466, a tire pressure suggestion 468, among others. In one or more implementations, the suggestion system 460 is, or includes at least a portion of, the machine learning model 204 of the electronic system 200. For example, the suggestion system 460 may be implemented as a classifier. In this regard, the portion of the machine learning model 204 implemented as the suggestion system 460 may be trained to predict a mapping between the detected vehicle path condition to a vehicle action suggestion such that the user of the vehicle 100 is provided with a suggestion on the next action or sequence of actions to take to best navigate the current driving situation. In one or more implementations, the portion of the machine learning model 204 implemented as the suggestion system 460 is different from the portion of the machine learning model 204 implemented as the semantic segmentation module 430. For example, the portion of the machine learning model 204 implemented as the suggestion system 460 and the portion of the machine learning model 204 implemented as the semantic segmentation module 430 may receive different inputs, be trained with different training datasets from the training data 202, and/or include different neural network branches.

In one or more implementations, the suggestion system 460 receives location data 472, prior knowledge information 492, and active learning information 496. The suggestion system 460 can utilize supplementary information, such as the location data 472 and other vehicle data (e.g., GPS location), to make informed decisions regarding the optimal suggestion. This decision-making process involves incorporating pre-defined (or prior) knowledge information 492, for instance, providing information on driving strategies in specific conditions. This prior knowledge information 492 may include, for example, details such as turning off traction control in snowy conditions. The prior knowledge information 492 can include other prior knowledge relating to prior vehicle actions depending on the previously traversed terrain and/or previously confronted obstructions.

In one or more implementations, the suggestion system 460 can be trained using the location data 472, the prior knowledge information 492, and/or the active learning information 496. For example, the training data 202 can include one or more training datasets that includes the prior knowledge information 492, the active learning information 496, and the location data 472 for training the portion of the machine learning model 204 implemented as the suggestion system 460.

In one or more other implementations, the suggestion system 460, by way of the portion of the machine learning model 204, can actively learn from real-time data such as the active learning information 496, including the location data 472. For example, if multiple drivers in a particular region have discovered more effective driving strategies, the suggestion system 460 can adapt and update its knowledge base accordingly. For example, this may include having the training data 202 updated to reflect the updated knowledge base. The initial phase involves establishing a foundational knowledge base, encompassing basic guidelines such as adjusting traction control in the presence of snow or increasing vehicle height when encountering water. Subsequent phases may involve more dynamic and active learning (e.g., using the active learning information 496) based on accumulated experiences from various vehicles encountering similar terrains or GPS locations. In some aspects, the ECU 150 may access a database having a collection of vehicle data associated with other vehicles.

Referring back to FIG. 3, at step 308, the vehicle 100 may send, via the one or more processors to a user interface (e.g., the infotainment system 160), a notification indicating suggestions that can be a respective action to be executed by the vehicle 100 based on the detected vehicle path condition. In one or more implementations, each of the suggestions provided for display can be a single option for selection by a user of the vehicle 100 such that its selection causes the suggestion to be activated for use. For example, referring back to FIG. 4, the notification can include one or more of the steering suggestion 462, the throttle suggestion 464, the ground clearance suggestion 466, the tire pressure suggestion 468, and the like. For example, the steering suggestion 462 may include a suggestion to cause the vehicle 100 to steer in a certain direction from a current position and/or direction. In another example, the throttle suggestion 464 may include a suggestion to cause the vehicle 100 to adjust its throttle to increase or reduce the speed of the vehicle 100 to within a certain range in response to a detected terrain and/or obstruction. In yet another example, the ground clearance suggestion 466 may include a suggestion to cause the vehicle 100 to raise or lower its suspension to a certain vehicle height and/or by a prescribed suspension height delta to maneuver over and/or around a detected terrain and/or obstruction. In still another example, the tire pressure suggestion 468 may include a suggestion to cause the vehicle 100 to inflate or deflate the tire pressure for one or more installed tires to traverse the detected terrain and/or obstruction. In one or more other implementations, each of the suggestions may include multiple sub-options for selection where each sub-option may be a granular vehicle action to be taken in relation to the primary suggestion. For example, the steering suggestion 462 may include one or more other steering-related sub-options for steering the vehicle 100 in response to any of the detected terrains and/or obstructions. Although FIG. 4 illustrates certain suggestions (e.g., 462, 464, 466, 468), the subject technology can provide an arbitrary number of suggestions in response to the detected terrains and/or obstructions without departing from scope of the present disclosure.

In one or more implementations, the portion of the machine learning model 204 implemented as the semantic segmentation module 430 primarily identifies terrain, supplemented by additional data sources. This integrated approach may combine diverse inputs to determine the optimal suggestion. Various vehicle sensors, aside from the camera (e.g., camera 110a-c), and existing grid data can contribute to this decision-making process performed by the machine learning model 204. The electronic system 200 can consolidate all inputs into a single decision-making entity that allows the machine learning model 204 to serve as the ultimate arbiter.

In one or more implementations, the terrain suggestions are tailored to different surfaces such as mud, dirt, water, and sand, commonly encountered in off-road conditions. In one or more other implementations, initial classifications of obstructions can be identified from various adventurous driving scenarios, although ongoing image processing of similar video frames may yield additional insights for inclusion.

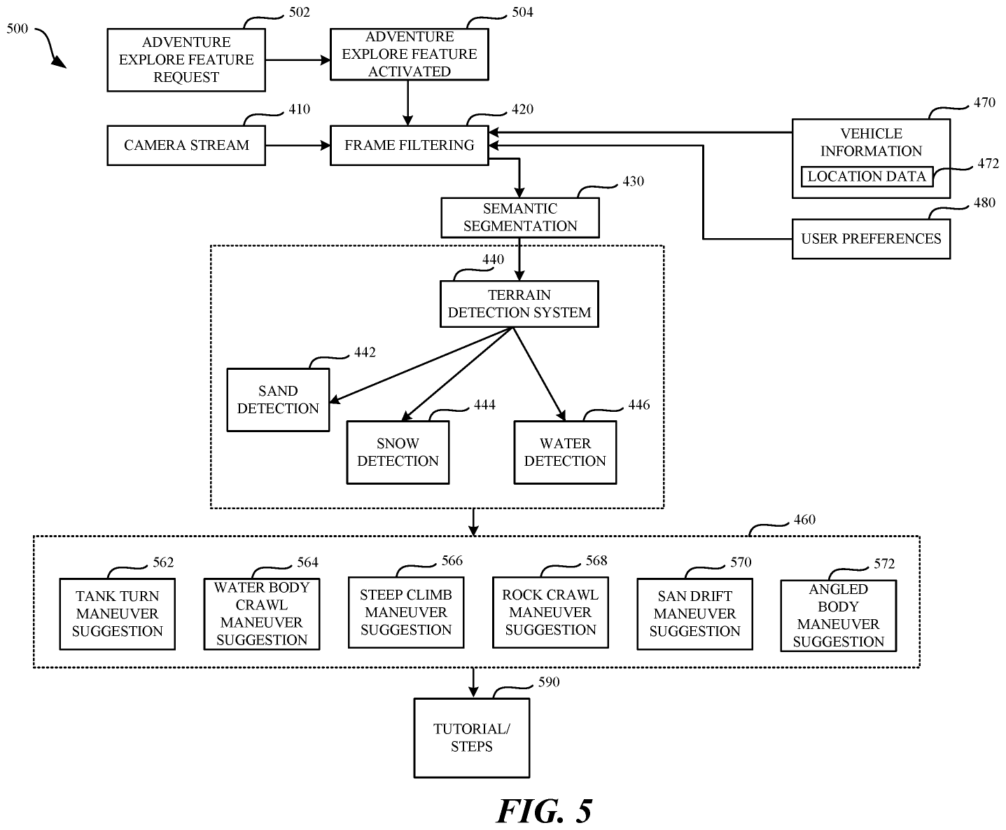

FIG. 5 illustrates a system flow diagram 500 for dynamic presentation of adventurous vehicle maneuver suggestions in accordance with one or more implementations of the subject technology. In one or more other implementations, the subject technology can provide guidance for specific driving maneuvers, such as drifting, distinct from terrain detection or obstruction alerts. The subject technology may also rely on user input in addition to the semantic image segmentation, offering steps or instructions upon request. The subject technology can provide non-real-time control signals in response to user-initiated requests for specific driving maneuvers or guidance, especially suited for drivers less experienced in off-road driving scenarios. The subject technology can interpret user-specified inputs, leveraging semantic image segmentation data from the surrounding environment and vehicle-related information to determine the terrain type and identify obstructions. Consequently, the suggestion system 460 generates appropriate maneuver suggestions tailored to the given circumstances as part of its functionality.

Referring to FIG. 5, at 502, the vehicle 100 may receive an adventure explore feature request. For example, the driver (or passenger) of the vehicle 100 may provide selection of an option provided for display on the infotainment system 160 (FIG. 1) that causes a request for activating the adventure explore feature to be sent to the ECU 150 (FIG. 1). Presentation of the adventure explore feature for activation can be discretionary for the user, allowing the user to decide whether to engage it before driving. Activation can primarily rely on user preference. For example, when driving in specific terrains such as sand dunes or near water bodies, the user of the vehicle 100 may opt to engage this adventure explore feature for suggestions in adventurous maneuvers in the detected terrain. In one or more implementations, the adventure explore feature request may include a user request indicating one or more requests for suggestions involving adventurous driving maneuvers in locations and/or terrains of interest to the user.

At 504 in FIG. 5, the adventure explore feature is activated. For example, once the request is received by the ECU 150, the adventure explore feature is activated. The operation at 504 may serve as a notification indicating the activation status of the adventure explore feature rather than an initiating action. It can function as a response or confirmation of the active state when the user of the vehicle 100 engages the adventure explore feature.

As illustrated in FIG. 5, the camera stream 410 is provided to the frame filtering module 420 that serves to filter the image data within the camera stream 410. The frame filtering module 420 can receive the vehicle information 470 of the vehicle 100 including the user preferences 480. The vehicle information 470 can include the location data 472 such as GPS location, speed information of the vehicle 100 and/or other vehicle sensor information. The user preferences 480 can include indication of terrain of interest to the user of the vehicle 100 and/or location of interest to the user of the vehicle 100.

The semantic segmentation module 430 receives the output from the frame filtering module 420 and can provide the semantic features to the suggestion system 460. Given the vehicle information 470, such as the location data 472, if the vehicle 100 is at a location of interest or if the semantic segmentation module 430 identifies terrains of interest in the scene, the suggestion system 460 can suggest possible adventurous driving maneuver suggestions, such as stunts, for the user of the vehicle 100 to attempt in the next portion of their trip. In one or more implementations, in addition to the suggestions as described with reference to FIG. 4, the suggestion system 460 can generate adventurous driving maneuver suggestions that include a tank turn maneuver suggestion 562, a water body crawl maneuver suggestion 564, a steep climb maneuver suggestion 566, a rock crawl maneuver suggestion 568, a sand drift maneuver suggestion 570, an angled body maneuver suggestion 572, among others. Each of these suggestions (e.g., 562-572) can be generated and/or provided for display based on the detected terrain along the vehicle path of the vehicle 100. In one or more other implementations, the suggestion system 460 can generate a tutorial 590 that includes an outline of steps for the user to follow to perform the suggested adventurous driving maneuver with the vehicle 100. For example, the tutorial 590 can be provided for display on the infotainment system 160 for enabling the user to follow a step-by-step guidance on the specific adventurous driving maneuver.

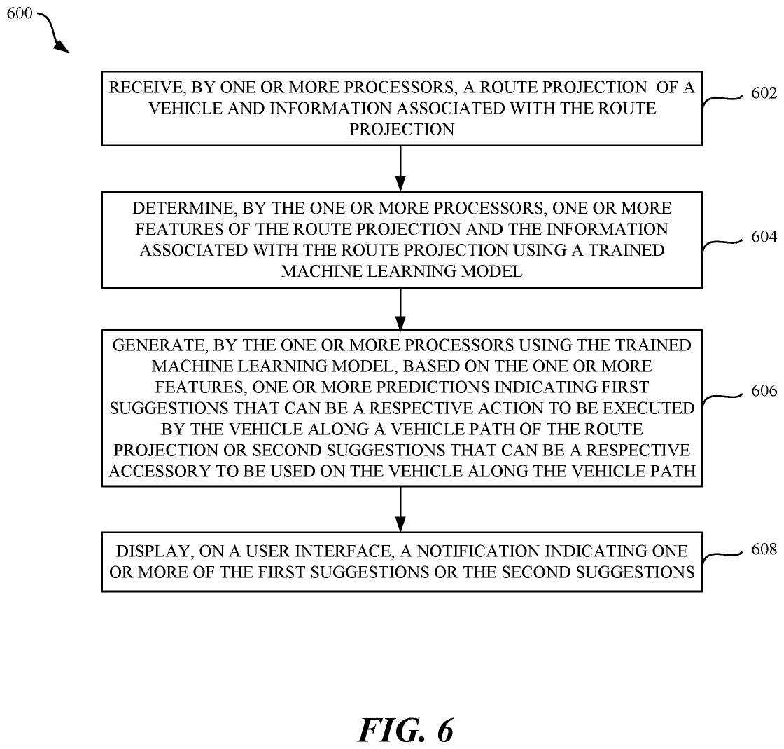

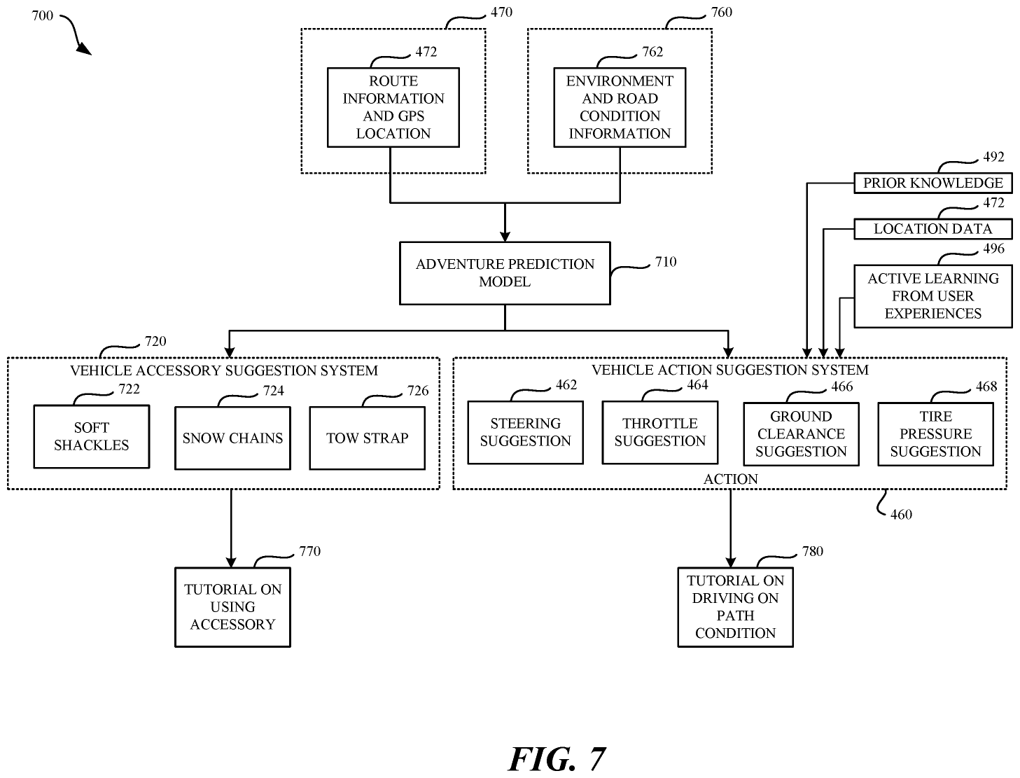

FIG. 6 illustrates a flow diagram of an example process 600 for dynamic presentation of vehicle accessory and action predictions in accordance with one or more implementations of the subject technology. For explanatory purposes, the process 600 is primarily described herein with reference to the vehicle 100 of FIG. 1 and/or various components thereof. However, the process 600 is not limited to the vehicle 100 of FIG. 1, and one or more steps (or operations) of the process 600 may be performed by one or more other structural components of the vehicle 100 and/or of other suitable moveable apparatuses, devices, or systems. Further, for explanatory purposes, some of the steps of the process 600 are described herein as occurring in serial, or linearly. However, multiple steps of the process 600 may occur in parallel. In addition, the steps of the process 600 need not be performed in the order shown and/or one or more steps of the process 600 need not be performed and/or can be replaced by other operations. Moreover, for explanatory purposes and for brevity of disclosure, some of the steps of the process 600 are described herein with reference to FIG. 7. FIG. 7 illustrates a system flow diagram 700 for dynamic presentation of vehicle action predictions in accordance with one or more implementations of the subject technology.

At step 602, one or more processors of the vehicle 100 (e.g., ECU 150, processing unit 1014), receive a route projection of the vehicle 100 and information associated with the route projection. In one or more implementations, the process 600 and the system flow diagram 700 may be performed offline prior to a user of the vehicle 100 starting a trip with the vehicle 100 (e.g., not in real time while driving). In one or more case scenarios, the user of the vehicle 100 can map their upcoming trip in a navigational system of the vehicle 100 and invoke an adventure predict process (e.g., the process 600). Upon doing so, the system can pull information from a weather application about the forecasts based on one or more GPS locations of interest from the user's mapped trip (e.g., places of interest, national parks, off-road trails, etc.). This pulled information can include road condition information such as snow, rain, ice, or the like.

Referring to FIG. 7, an adventure prediction model 710 receives the vehicle information 470 and the data source information 760. The vehicle information 470 can include the location data 472 indicating the GPS location of the vehicle 100, speed information of the vehicle 100, or other sensor information from sensors installed on the vehicle 100. The location data 472 may include navigational mapping data for a projected route (or trip) of the vehicle 100. The location data 472 can be used to obtain terrain information such as information indicating what portion of the mapped trip pertains to sand, water, gravel, rocks, or the like. The data source information 760 may be publicly-available data accessible through network-connected devices and can include environmental information (e.g., weather data, topography, or the like) and/or road condition information (e.g., road closures, road hazards, construction zones, or the like). For example, the data source information 760 includes environment and road condition information 762, which includes weather forecast information relevant to the locations traversed by way of the projected route of the vehicle 100 along with road conditions indicating the status of roads and traffic conditions along the projected route. In one or more other implementations, the process 600 and the system flow diagram 700 may be performed during the user's trip with the vehicle 100 (e.g., in real time while driving).

At step 604, the vehicle 100 may determine, using the one or more processors, one or more features of the route projection and the information associated with the route projection using a trained machine learning model (e.g., the machine learning model 204). In one or more implementations, a portion of the machine learning model 204 of FIG. 2 may be implemented as an adventure prediction model 710 that includes one or more neural network layers configured to extract high-level metadata of the route projection including the information associated with the route projection. The adventure prediction model 710 may extract the metadata from the location data 472 and/or the environment and road condition information 762 and provide this metadata as features to downstream suggestion systems (e.g., 460, 720). In one or more other implementations, the adventure prediction model 710 may generate a latent representation of the route projection including the information associated with the route projection.

At step 606, the one or more processors of the vehicle 100 generate, using the machine learning model 204, based on the one or more features, one or more predictions indicating first suggestions that can be a respective action to be executed by the vehicle along a vehicle path of the route projection and/or second suggestions that can be a respective accessory to be used by the vehicle along the vehicle path. In one or more implementations, a portion of the machine learning model 204 of FIG. 2 may be implemented as either of a vehicle action suggestion system (e.g., the suggestion system 460) or a vehicle accessory suggestion system 720 that serve as respective classifiers. In one or more implementations, the vehicle action suggestion system may serve as a first classifier configured to identify the type of vehicle action to be taken by the vehicle 100 from these learned features by up sampling and combining information from different layers in the portion of the machine learning model 204 that is implemented as the suggestion system 460. In one or more other implementations, the vehicle accessory suggestion system 720 may serve as a second classifier configured to identify the type of vehicle accessory to be used by the vehicle 100 from these learned features by up sampling and combining information from different layers in the portion of the machine learning model 204 that is implemented as the vehicle accessory suggestion system 720.

Referring to FIG. 7, once a trip is mapped by a user of the vehicle 100, given the vehicle information 470 and data source information 760 such as mapping data and weather forecasts retrieved from an online data source via a network (e.g., Internet), the vehicle accessory suggestion system 720 can recommend what vehicle accessory the user should carry on board the vehicle 100 and provide tutorials on how to use such vehicle accessory, and the suggestion system 460 can suggest one or more driving maneuvers that may be required to navigate the road conditions on an upcoming (or subsequent) trip leg. For example, the vehicle accessory suggestion system 720 can generate a suggestion for what vehicle accessory should be on board the vehicle 100 based on the detected terrain along the projected route. For example, for a snowy terrain based on the snow detection 444 (FIG. 4) by the terrain detection system 440 (FIG. 4), the vehicle accessory suggestion system 720 may suggest a vehicle accessory for such snowy conditions, such as soft shackles suggestion 722, snow chains suggestion 724, tow strap suggestion 726, among others. In turn, the suggestion system 460 may suggest an action that includes a driving maneuver to navigate the detected terrain. For example, the suggested action can include the steering suggestion 462, the throttle suggestion 464, the ground clearance suggestion 466, and/or the tire pressure suggestion 468, among others.

In one or more other implementations, the vehicle accessory suggestion system 720 can generate a tutorial 770 that includes an outline of steps for the user to follow on how to use the suggested vehicle accessory (e.g., 722-726). In one or more other implementations, the suggestion system 460 also can generate a tutorial 780 that includes an outline of steps for the user to follow on how to drive on the path condition using the suggested vehicle actions (e.g., driving maneuvers relating to suggestions 462-468).

At 608, the one or more processors of the vehicle 100 can provide for display a notification indicating one or more of the first suggestions or the second suggestions. In one or more implementations, each of the suggestions provided for display can be a single option for selection by a user of the vehicle 100 such that its selection causes the suggestion to be activated for use. For example, referring back to FIG. 7, the notification can include one or more of the first suggestions that include the steering suggestion 462, the throttle suggestion 464, the ground clearance suggestion 466, the tire pressure suggestion 468, and the like. In another example, the notification can include one or more of the second suggestions that include the soft shackles suggestion 722, the snow chains suggestion 724, the tow strap suggestion 726, and the like. In one or more other implementations, each of the suggestions may include multiple sub-options for selection where each sub-option may be a granular vehicle action to be taken in relation to the primary suggestion. For example, the tow strap suggestion 726 may include one or more other tow-related sub-options for towing objects on or coupled to the vehicle 100 in response to any of the predicted terrains and/or road conditions. Although FIG. 7 illustrates certain suggestions (e.g., 462, 464, 466, 468, 722, 724, 726), the subject technology can provide an arbitrary number of suggestions in response to the predicted terrains and/or road conditions without departing from scope of the present disclosure.

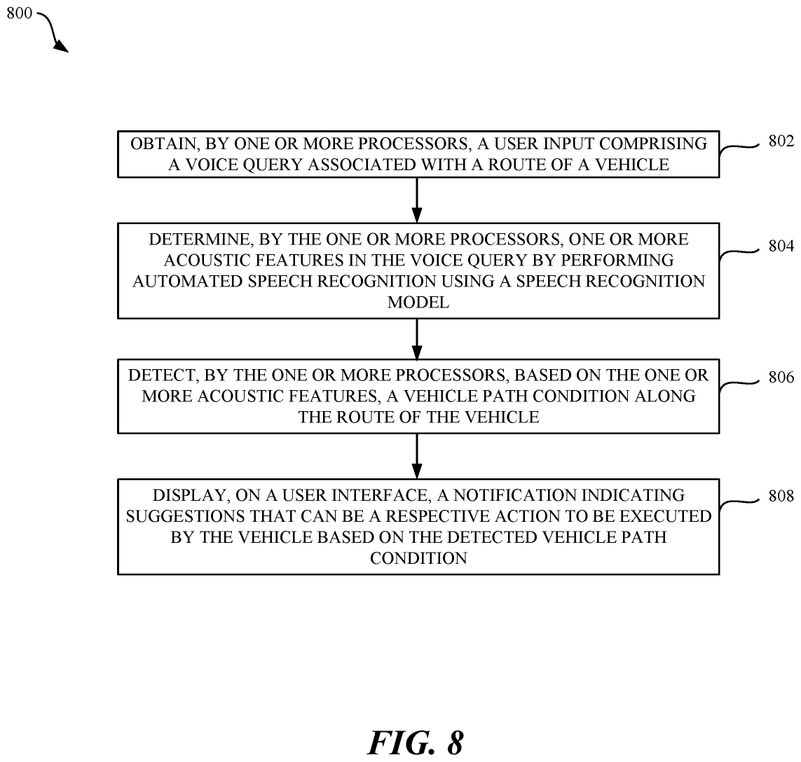

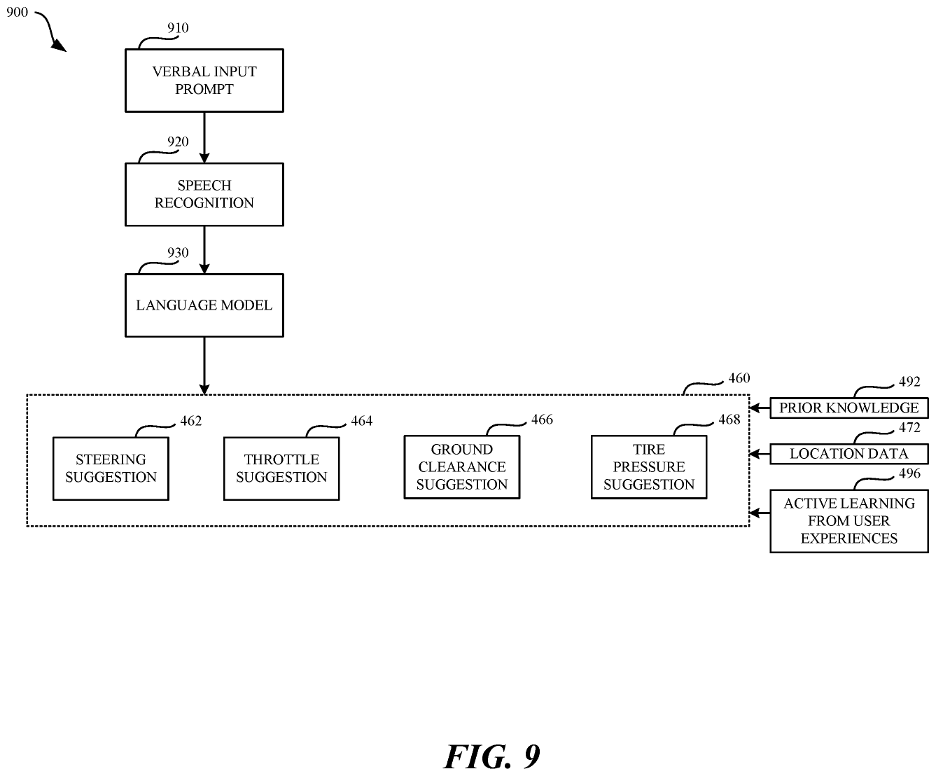

FIG. 8 illustrates a flow diagram of an example process 800 for dynamic presentation of vehicle action suggestions based on speech input in accordance with one or more implementations of the subject technology. For explanatory purposes, the process 800 is primarily described herein with reference to the vehicle 100 of FIG. 1 and/or various components thereof. However, the process 800 is not limited to the vehicle 100 of FIG. 1, and one or more steps (or operations) of the process 800 may be performed by one or more other structural components of the vehicle 100 and/or of other suitable moveable apparatuses, devices, or systems. Further, for explanatory purposes, some of the steps of the process 800 are described herein as occurring in serial, or linearly. However, multiple steps of the process 800 may occur in parallel. In addition, the steps of the process 800 need not be performed in the order shown and/or one or more steps of the process 800 need not be performed and/or can be replaced by other operations. Moreover, for explanatory purposes and for brevity of disclosure, some of the steps of the process 800 are described herein with reference to FIG. 9. FIG. 9 illustrates a system flow diagram 900 for dynamic presentation of vehicle action suggestions based on speech input in accordance with one or more implementations of the subject technology.

Referring to FIG. 9, within this framework, an alternative pathway within the pipeline is provided such that the vehicle camera system (e.g., cameras 110a, 110b, 110c) and the semantic segmentation module 430 is supplanted by the integration of a speech recognition module 920. This approach can enable users to engage with the system in a hands-free manner, particularly advantageous in scenarios such as driving in adverse weather conditions such as in a scenario where the user of the vehicle 100 finds themselves navigating through snow-covered roads. Rather than relying on visual cues, the user of the vehicle 100 can interact with the system by vocalizing their query (e.g., a verbal input prompt 910) using an input device of the vehicle 100 such as a microphone integrated into the vehicle 100. For instance, the user may inquire, “The roads are covered in snow, what precautions should I take to ensure safe driving?”

At step 802, the vehicle 100 may receive, using one or more processors (e.g., ECU 150 of FIG. 1), a user input that includes a voice query associated with a route of the vehicle 100. Referring to FIG. 9, a verbal input prompt 910 can be received.

At step 804, the vehicle 100 may determine, using the one or more processors, one or more acoustic features in the voice query by performing automated speech recognition using a speech recognition model. Referring to FIG. 9, the voice query can be processed by the speech recognition module 920, leveraging Automatic Speech Recognition (ASR) models to transcribe and interpret the user's query (e.g., verbal input prompt 910). For example, the ASR model may first convert spoken language commands or observations from the vehicle's surroundings into text transcripts. These transcripts can contain information about the vehicle's path condition, such as road conditions, traffic density, weather conditions, and any potential hazards.

At step 806, the vehicle 100 may detect, using the one or more processors, based on the one or more acoustic features, a vehicle path condition along the route of the vehicle. In some aspects, the vehicle path condition is detected based on the one or more acoustic features. Referring to FIG. 9, the processed input from the speech recognition model can be relayed to the language model 930, where natural language processing algorithms and/or machine learning techniques analyze the context. For example, the natural language model can process these text transcripts to extract relevant information about the vehicle's path condition. The natural language model can employ various natural language processing (NLP) techniques such as named entity recognition (NER), sentiment analysis, and keyword extraction to identify key phrases or words indicative of different path conditions. For example, phrases such as “slippery road,” “heavy traffic,” or “road construction ahead” can signal hazardous path conditions. Additionally, the natural language model can analyze the context of the verbal inputs to infer the severity and relevance of the identified path conditions. The natural language model may consider factors like the speaker's tone of voice, the presence of urgency or concern in the speech, and any additional contextual cues provided in the conversation.

Referring to FIG. 9, the contextual output from the language model 930 can be relayed to the suggestion system 460 to generate tailored suggestions in real-time. The suggestions generated by the suggestion system 460 can be comprehensive and intuitive, providing users with actionable insights and guidance on navigating through challenging driving conditions. In one or more other implementations, the system flow diagram 900 includes a Text-to-Speech (TTS) model communicatively coupled to, or included as part of, the suggestion system 460, enabling it to convert the generated suggestions into natural-sounding speech.

In one or more implementations, the suggestion system 460 is, or includes at least a portion of, the machine learning model 204 of the electronic system 200. For example, the suggestion system 460 may be implemented as a classifier. In this regard, the portion of the machine learning model 204 implemented as the suggestion system 460 may be trained to predict a mapping between the detected vehicle path condition to a vehicle action suggestion such that the user of the vehicle 100 is provided with a suggestion on the next action or sequence of actions to take to best navigate the current driving situation.

In one or more implementations, the suggestion system 460 receives location data 472, prior knowledge information 492, and active learning information 496. The suggestion system 460 can utilize supplementary information, such as the location data 472 and other vehicle data (e.g., GPS location), to make informed decisions regarding the optimal suggestion. This decision-making process involves incorporating pre-defined (or prior) knowledge information 492, for instance, providing information on driving strategies in specific conditions. This prior knowledge information 492 may include, for example, details such as turning off traction control in snowy conditions. The prior knowledge information 492 can include other prior knowledge relating to prior vehicle actions depending on the previously traversed terrain and/or previously confronted obstructions.

In one or more implementations, the suggestion system 460 can be trained using the location data 472, the prior knowledge information 492, and/or the active learning information 496. For example, the training data 202 can include one or more training datasets that includes the prior knowledge information 492, the active learning information 496, and the location data 472 for training the portion of the machine learning model 204 implemented as the suggestion system 460.

At step 808, the vehicle 100 may send, via the one or more processors to a user interface (e.g., the infotainment system 160 of FIG. 1), a notification indicating the generated suggestions that can be a respective action to be executed by the vehicle 100 based on the detected vehicle path condition. In one or more implementations, each of the suggestions provided for display can be a single option for selection by a user of the vehicle 100 such that its selection causes the suggestion to be activated for use. For example, referring back to FIG. 9, the notification can include one or more of the steering suggestion 462, the throttle suggestion 464, the ground clearance suggestion 466, the tire pressure suggestion 468, among others. Although FIG. 9 illustrates certain suggestions (e.g., 462, 464, 466, 468), the subject technology can provide an arbitrary number of suggestions in response to the detected terrains and/or obstructions without departing from scope of the present disclosure.

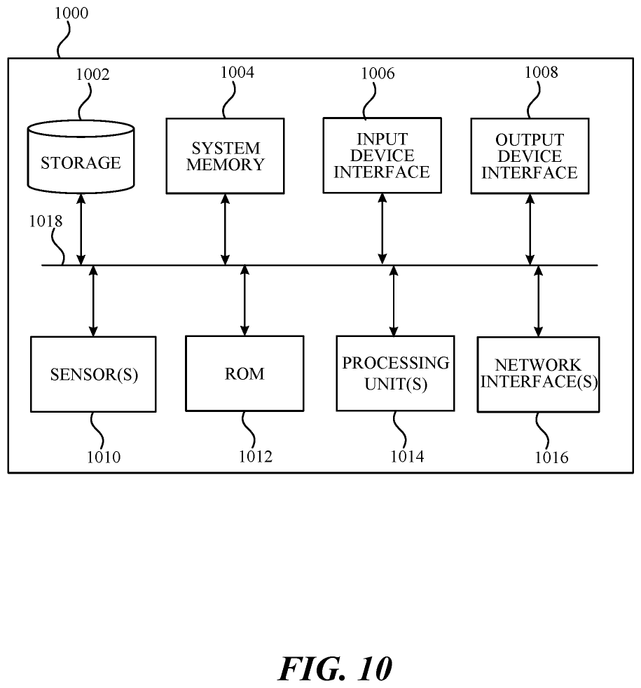

FIG. 10 illustrates an example electronic system 1000 with which aspects of the present disclosure may be implemented. The electronic system 1000 can be, and/or can be a part of, any electronic device for providing the features and performing processes described in reference to FIGS. 1-7, including but not limited to a vehicle, computer, and server. The electronic system 1000 may include various types of computer-readable media and interfaces for various other types of computer-readable media. The electronic system 1000 includes a persistent storage device 1002, system memory 1004 (and/or buffer), input device interface 1006, output device interface 1008, sensor(s) 1010, ROM 1012, processing unit(s) 1014, network interface 1016, bus 1018, and/or subsets and variations thereof. In one or more implementations, the ECU 150 of FIG. 1 is, or includes at least a portion of, the electronic system 1000.

The bus 1018 collectively represents all system, peripheral, and chipset buses that communicatively connect the numerous internal devices and/or components of the electronic system 1000, such as any of the components of the vehicle 100 discussed above with respect to FIG. 1. In one or more implementations, the bus 1018 communicatively connects the one or more processing unit(s) 1014 with the ROM 1012, the system memory 1004, and the persistent storage device 1002. From these various memory units, the one or more processing unit(s) 1014 retrieves instructions to execute and data to process in order to execute the processes of the subject disclosure. The one or more processing unit(s) 1014 can be a single processor or a multi-core processor in different implementations. In one or more implementations, one or more of the processing unit(s) 1014 may be included on the ECU 150.

The ROM 1012 stores static data and instructions that are needed by the one or more processing unit(s) 1014 and other modules of the electronic system 1000. The persistent storage device 1002, on the other hand, may be a read-and-write memory device. The persistent storage device 1002 may be a non-volatile memory unit that stores instructions and data even when the electronic system 1000 is off. In one or more implementations, a mass-storage device (such as a magnetic or optical disk and its corresponding disk drive) may be used as the persistent storage device 1002.

In one or more implementations, a removable storage device (such as a flash drive, and its corresponding disk drive) may be used as the persistent storage device 1002. Like the persistent storage device 1002, the system memory 1004 may be a read-and-write memory device. However, unlike the persistent storage device 1002, the system memory 1004 may be a volatile read-and-write memory, such as RAM. The system memory 1004 may store any of the instructions and data that one or more processing unit(s) 1014 may need at runtime. In one or more implementations, the processes of the subject disclosure are stored in the system memory 1004, the persistent storage device 1002, and/or the ROM 1012. From these various memory units, the one or more processing unit(s) 1014 retrieves instructions to execute and data to process in order to execute the processes of one or more implementations.

The persistent storage device 1002 and/or the system memory 1004 may include one or more machine learning models. Machine learning models, such as those described herein, are often used to form predictions, solve problems, recognize objects in image data, and the like. For example, machine learning models described herein may be used to predict semantic information and boundary region information for one or more pixels of an image. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 1018 also connects to the input device interfaces 1006 and output device interfaces 1008. The input device interface 1006 enables a user to communicate information and select commands to the electronic system 1000. Input devices that may be used with the input device interface 1006 may include, for example, alphanumeric keyboards, touch screens, and pointing devices. The output device interface 1008 may enable the electronic system 1000 to communicate information to users. For example, the output device interface 1008 may provide the display of images generated by electronic system 1000. Output devices that may be used with the output device interface 1008 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. In one or more implementations, the infotainment system 160 of FIG. 1 is, or includes at least a portion of, the input device interface 1006 and/or at least a portion of the output device interface 1008.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1018 also connects to sensor(s) 1010. The sensor(s) 1010 may include a geo-location sensor, which may be used in determining device position based on positioning technology. For example, the geo-location sensor may provide for one or more of global navigation satellite system (GNSS) positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 1010 may be utilized to detect movement, travel, and orientation of the electronic system 1000. For example, the sensor(s) may include an accelerometer, a rate gyroscope, and/or other motion-based sensor(s). The sensor(s) 1010 may include one or more biometric sensors and/or cameras for authenticating a user.

The bus 1018 also couples the electronic system 1000 to one or more networks and/or to one or more network nodes through the one or more network interface(s) 1016. In this manner, the electronic system 1000 can be a part of a network of computers (such as a local area network or a wide area network). Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the present disclosure. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different orders. Some of the steps, operations, or processes may be performed simultaneously. The accompanying method claims, if any, present elements of the various steps, operations, or processes in a sample order, and are not meant to be limited to the specific order or hierarchy presented. These may be performed in serial, linearly, in parallel, or in different order. It should be understood that the described instructions, operations, and systems can generally be integrated together in a single software/hardware product or packaged into multiple software/hardware products.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

1. A method, comprising:
obtaining, by one or more processors, an image from a camera of a vehicle;
determining, by the one or more processors, one or more semantic features in the image by performing image segmentation on the image using a trained machine learning model;
detecting, by the one or more processors, based on the one or more semantic features, a vehicle path condition in the image; and
displaying, on a user interface, a notification indicating a plurality of suggestions that can be a respective action to be executed by the vehicle based on the vehicle path condition.

2. The method of claim 1, wherein performing the image segmentation comprises:
dividing the image into a plurality of image segments; and
assigning, using the trained machine learning model, a semantic label to each of the plurality of image segments,
wherein each of the one or more semantic features includes the semantic label of a corresponding image segment of the plurality of image segments.

3. The method of claim 2, wherein detecting the vehicle path condition comprises:
determining, using the trained machine learning model, one or more boundary regions in the plurality of image segments, wherein the vehicle path condition is detected based on the one or more semantic features and the one or more boundary regions.

4. The method of claim 1, wherein detecting the vehicle path condition comprises detecting a type of terrain along a path of the vehicle within a scene of the image.

5. The method of claim 4, further comprising generating the plurality of suggestions based at least in part on the detected type of terrain along the path of the vehicle.

6. The method of claim 1, wherein detecting the vehicle path condition comprises detecting a type of hindrance along a path of the vehicle within a scene of the image.

7. The method of claim 6, further comprising generating the plurality of suggestions based at least in part on the detected type of hindrance along the path of the vehicle.

8. The method of claim 1, wherein detecting the vehicle path condition comprises detecting one or more of a type of terrain or a type of hindrance along a path of the vehicle within a scene of the image, and further comprising generating the plurality of suggestions based at least in part on the detected type of hindrance or the detected type of terrain along the path of the vehicle.

9. The method of claim 1, further comprising receiving, via the user interface, user input indicating a selection of at least one of the plurality of suggestions corresponding to an action to be executed by the vehicle.

10. The method of claim 1, further comprising receiving vehicle data information associated with the vehicle, further comprising generating the plurality of suggestions based at least in part on the vehicle path condition and the vehicle data information.

11. The method of claim 1, further comprising produce the trained machine learning model by training a neural network to predict semantic information and boundary region information for one or more pixels of the image.

12. A system comprising:
a memory; and
at least one processor coupled to the memory and configured to:
generate a segmentation mask comprising a plurality of semantic features that correspond to respective pixels of an image from a camera of a vehicle, wherein the segmentation mask is generated by performing image segmentation on the image using a trained machine learning model;
detect one or more vehicle path conditions in the image by classifying each of the plurality of semantic features in the segmentation mask; and
provide for display one or more suggestions that can be a respective action to be executed by the vehicle based on the one or more vehicle path conditions.

13. The system of claim 12, wherein the at least one processor configured to generate the segmentation mask is further configured to:
divide the image into a plurality of image segments; and
assign, using the trained machine learning model, a semantic label to each of the plurality of image segments,
wherein each of the plurality of semantic features includes the semantic label of a corresponding image segment of the plurality of image segments.

14. The system of claim 13, wherein the at least one processor configured to detect the one or more vehicle path conditions is further configured to:
determine, using the trained machine learning model, one or more boundary regions in the plurality of image segments, wherein the one or more vehicle path conditions is detected based on the plurality of semantic features and the one or more boundary regions.

15. The system of claim 12, wherein the at least one processor configured to detect the one or more vehicle path conditions is further configured to detect a type of terrain along a path of the vehicle within a scene of the image.

16. The system of claim 15, wherein the at least one processor is further configured to generate the one or more suggestions based at least in part on the detected type of terrain along the path of the vehicle.

17. The system of claim 12, wherein the at least one processor configured to detect the one or more vehicle path conditions is further configured to detect a type of hindrance along a path of the vehicle within a scene of the image.

18. The system of claim 17, wherein the at least one processor is further configured to generate the one or more suggestions based at least in part on the detected type of hindrance along the path of the vehicle.

19. The system of claim 12, wherein the at least one processor configured to detect the one or more vehicle path conditions is further configured to detect one or more of a type of terrain or a type of hindrance along a path of the vehicle within a scene of the image, and wherein the at least one processor is further configured to generate the one or more suggestions based at least in part on the detected type of hindrance or the detected type of terrain along the path of the vehicle.

20. A vehicle, comprising:
a camera; and
a processor configured to:
provide an image from the camera to a trained machine learning model configured to generate a segmentation mask comprising a plurality of semantic features that correspond to respective pixels of the image and detect one or more vehicle path conditions in the image by classifying each of the plurality of semantic features in the segmentation mask;
provide for display one or more suggestions that can be a respective action to be executed by the vehicle based on the one or more vehicle path conditions; and
cause the respective action to be executed by the vehicle based at least in part on a received input indicating selection of at least one of the one or more suggestions.
